(19) United States
(12) Patent Application Publication
(10) Pub. No.: US 2011/0169690 A1
(43) Pub. Date: Jul. 14, 2011

(54) SATELLITE POSITIONING

(76) Inventors: Andrew T. Yule, West Sussex (GB); Ian Simmons, West Sussex (GB)

(21) Appl. No.: 13/063,453

(22) PCT Filed: Sep. 9, 2009
(86) PCT No.: PCT/GB09/51143

§ 371 Date: Mar. 10, 2011

(30) Foreign Application Priority Data
Sep. 12, 2008 (GB) 0816701.7

(51) Int. Cl. G01S 19/42

(52) U.S. Cl. 342/357.25

(57) ABSTRACT

A method of estimating the position of a first event of interest using a satellite positioning system. The method comprises: performing in response to the first event a satellite reception function; determining at some later time whether it is possible to calculate a position estimate from signals resulting from the satellite reception function; and, if not, estimating the position of the first event based on a position estimate of a second event, wherein the second event is that closest in time to the first for which a position estimate is available. Thus, the method can provide a position estimate for the first event even if the satellite reception function fails.

This invention relates to methods for position estimation using a global navigation satellite system (GNSS). It is particularly relevant for estimating the locations of each of a series of events, such as the location of capture of photographs.

“Geo-tagging” refers to recording the location of a place or event of interest, typically along with some other record, such as a sound recording, image, video or weblog ('blog) entry. Geo-tagging is an increasingly popular way to annotate and organize recorded information like images and videos. By adding location metadata to the media, users can search and browse an archive in interesting and intuitive ways—for example by plotting the set of locations on a map.

To avoid the labour-intensive task of manually typing the location names or geographic coordinates necessary to create such annotations, satellite positioning is increasingly being used to provide precise location metadata.

Satellite positioning systems, such as the Global Positioning System (GPS), enable a receiver to calculate its position based on the measured time of arrival of signals from a set of orbiting satellites (known as space vehicles—SVs).

Although, in theory, GPS satellites provide global coverage, in practice there will be local environments in which clear reception of the satellite signals may be impossible. This typically occurs when the view of the sky is obscured by natural features (for example trees and mountains) or man-made obstacles (for example, when in or near a building). If satellite signals cannot be detected, a position fix may have reduced accuracy or be impossible to calculate. Interference (including reflected multipath satellite signals) can also prevent or distort position estimation.

According to an aspect of the current invention, there is provided a method of estimating the position of a first event of interest using a satellite positioning system, the method comprising: performing in response to the first event a satellite reception function; determining at some later time whether it is possible to calculate a position estimate from signals resulting from the satellite reception function; and, if not, estimating the position of the first event based on a position estimate of a second event, wherein the second event is that closest in time to the first for which a position estimate is available, so as to provide a position estimate for the first event even if the satellite reception function fails.

The method allows the position of every event to be estimated, provided suitable known positions are available. In particular, it allows the position of the first event to be estimated even though the reception of satellite signals at the time and location of that event has failed. It does so by synthesizing the missing estimate based on at least one nearest event (in time) for which satellite positioning was successful (or for which a position estimate is available by other means). This estimate will be accurate to the extent that the movement of the user is predictable between the events (instants) for which a known position can be derived. By assigning at least an artificial estimate of position for every event, the method increases user satisfaction, since there are no longer any events without position information. Furthermore, the subsequent consumption of the position estimates may be made easier, since databases and software applications do not need to cater for the case that the position estimate is missing.

The second event may occur after the first.

This represents a non-causal inference of position. That is, the position of the first event is back-predicted from the known position of a subsequent second event. This implies that the method returns to previous failed position estimates and corrects/updates them with later-gathered satellite positioning information. By operating both forwards and backwards in time, the method increases the accuracy of the synthesized estimates.

The method preferably comprises, if it is not possible to calculate a position estimate from the signals, estimating the position of the first event based on the position estimate of the second event and a position estimate of a third event, wherein: the third event occurred before the first; and the step of estimating the position of the first event comprises interpolating between the position estimates of the second and third events.

By picking the two nearest successful position estimates, one before and one after the event, the method can use interpolation (based on the comparative time differences) to predict the location of the intermediate (first) event of interest. Further events and known positions either side of the event of interest provide additional information, which can support higher order interpolation methods, to improve accuracy.

The method may require that at least one of the second and third events occurred within a predetermined maximum time limit before or after the first event.

The uncertainty in the inferred position estimate will increase as the spacing between the events used as the basis for prediction and the event of interest (first event) increases. By setting a maximum time-difference threshold above which a neighbouring event will not be used, the method limits the introduction of errors in the estimated positions.

The method may comprise, if it is not possible to calculate a position estimate from the signals, estimating the position of the first event based on a velocity estimate associated with the time and position of at least one event.

Velocity estimates for one or more of the events provide an additional constraint to improve the prediction/interpolation of the missing position. The velocity might correspond to the first, second or third event (that is, the event for which satellite positioning failed, or any of the events forming the reference points for interpolation).

At least one of the first event and the second event may be the taking of a photograph.

Geo-tagging of photographs is a particularly important application. The current method is also particularly relevant here, since photographs are likely to be distributed individually, rather than always in the context of a whole collection. The current method guarantees that every photograph will have an associated position estimate (albeit potentially artificial/synthesized) so that the chance of distributing/sharing one photograph with missing position data is eliminated.

The method may further comprise alerting a user to the potentially reduced accuracy of the estimated position.

This prevents false reliance on data which may be less accurate than normal (that is, less accurate than the satellite-based position estimates for other events). The synthesized information might be flagged in any of a number of ways, such as using an alternative symbol or displaying the expected error on a map; or providing a numerical precision value.

According to another aspect of the invention, there is provided a method of estimating the position of a first event of interest using a satellite positioning system, the method comprising: receiving recorded data samples resulting from a satellite reception function, the satellite reception function having been performed in response to the first event; determining whether it is possible to calculate a position estimate from the recorded data samples; and, if not, estimating the position of the first event based on a position estimate of a second event, wherein the second event is that closest in time to the first for which a position estimate is available, so as to provide a position estimate for the first event even if the satellite reception function failed.

This version of the method provides for caching of received satellite signals by a simple receiver, followed by later uploading to another device to carry out the position estimation function. In this offline case, the method is even more valuable, since—unlike real-time satellite positioning—there is no possibility to re-try satellite reception.

According to still another aspect of the invention, there is provided apparatus adapted to estimate the position of a first event of interest using a satellite positioning system, the apparatus comprising: a receiver, adapted to perform in response to the first event a satellite reception function; and a processor, adapted to determine at some later time whether it is possible to calculate a position estimate from signals resulting from the satellite reception function and, if not, to estimate the position of the first event based on a position estimate of a second event, wherein the second event is that closest in time to the first for which a position estimate is available, so as to provide a position estimate for the first event even if the satellite reception function fails.

This apparatus is thus adapted to perform the first method described above.

The receiver may be connected to a camera; and at least one of the first and second events may be the taking of a photograph by the camera.

If the receiver is connected directly to a camera (including being integrated in the camera itself) the satellite reception function can be triggered automatically—for example, by the shutter release signal. Alternatively, the photo-event (or indeed other event of interest) can be noted by a manual input by the user.

According to yet another aspect of the invention there is provided apparatus adapted to estimate the position of a first event of interest using a satellite positioning system, the apparatus comprising: an input, operable to receive recorded data samples resulting from a satellite reception function, the satellite reception function having been performed in response to the first event; and a processor, adapted to determine whether it is possible to calculate a position estimate from the recorded data samples, and, if not, to estimate the position of the first event based on a position estimate of a second event, wherein the second event is that closest in time to the first for which a position estimate is available, so as to provide a position estimate for the first event even if the satellite reception function failed.

This apparatus is thus adapted to perform the second method described above.

The invention will now be described by way of example, with reference to the accompanying drawings, in which:

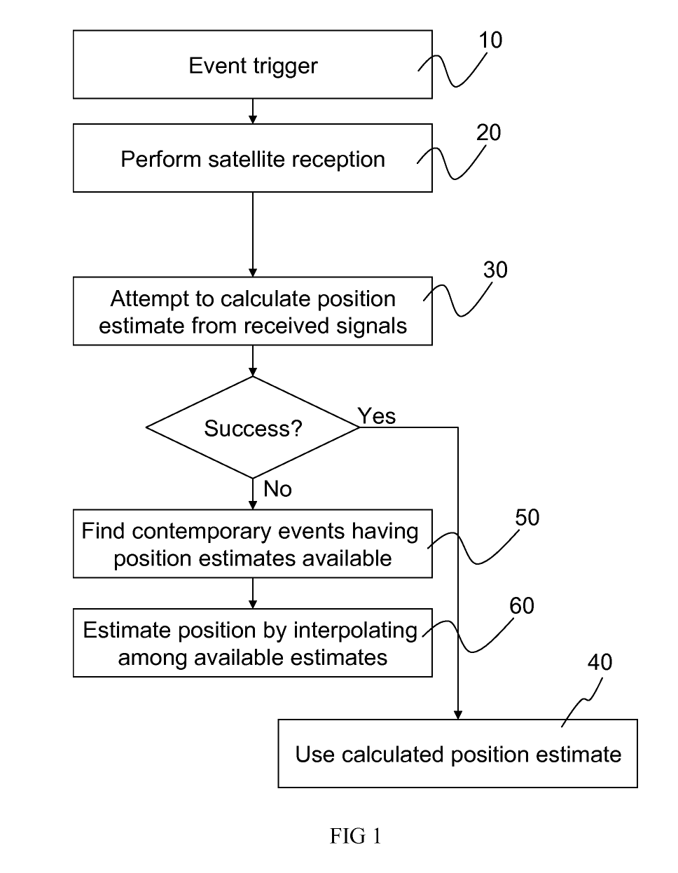

FIG. 1 is a flow-chart of a method of estimating position according to an embodiment;

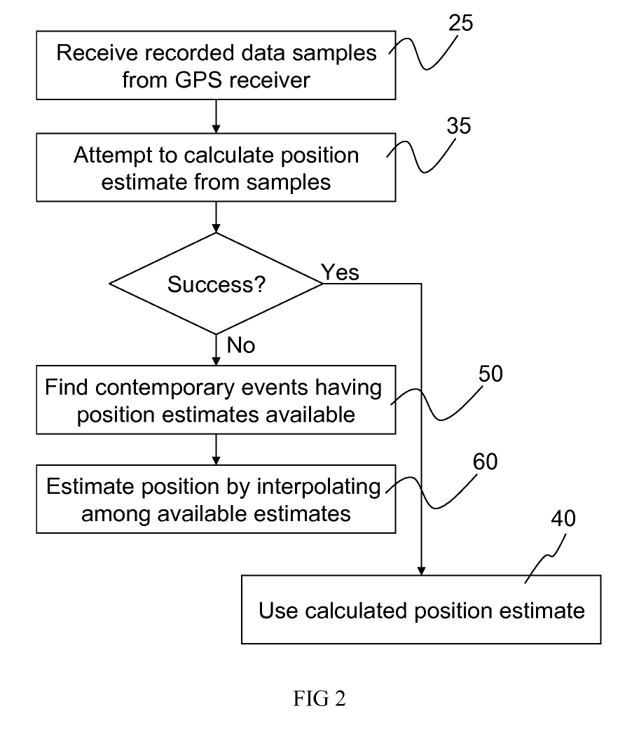

FIG. 2 is a flow-chart of a method of estimating position according to another embodiment;

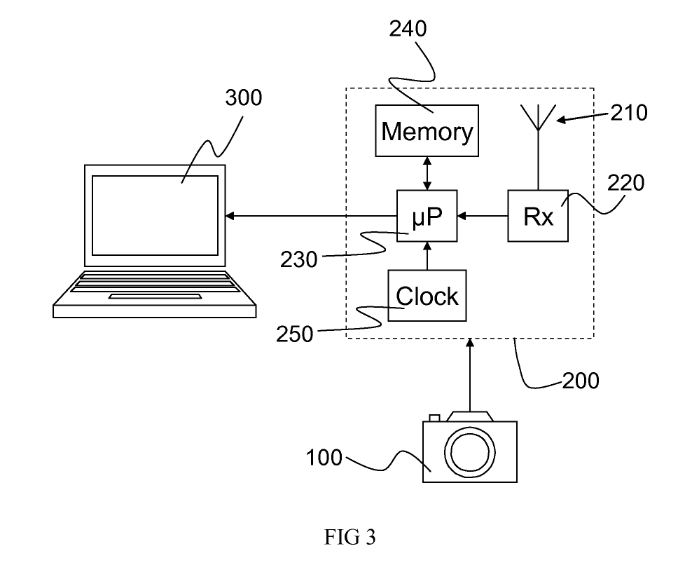

FIG. 3 is a diagram of an apparatus according to an embodiment; and

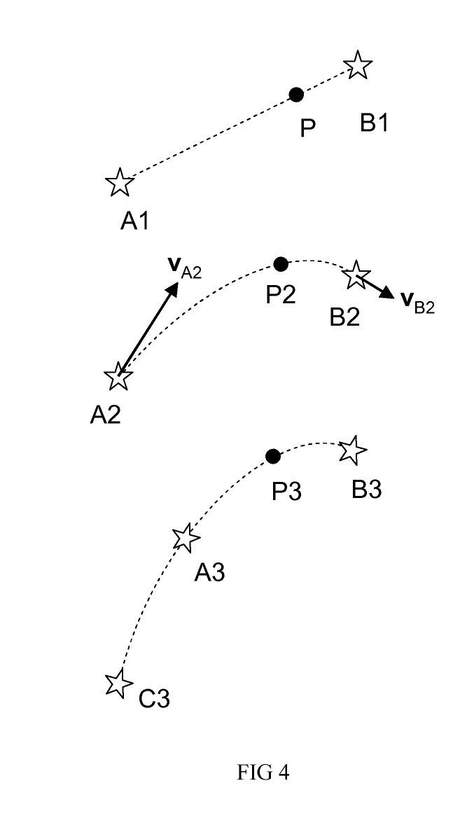

FIG. 4 shows examples of various position-interpolation strategies.

Like features are given like reference numerals throughout. It should be noted that these figures are diagrammatic and not drawn to scale. Relative dimensions and proportions of parts of these figures have been shown exaggerated or reduced in size, for the sake of clarity and convenience in the drawings.

The inventors have realised that the effects of interference and obstruction of satellite signals can make geo-tagging of a particular event of interest, in a particular place, impossible. In this regard, the requirements of a geo-tagging application are different from those of a navigation application (where satellite positioning, such as GPS, is well known). In the navigation case, if a satellite position fix fails, the most appropriate strategy is usually to continue re-trying (searching for satellites) until a fix is found again. In navigation, positions are of equal interest, in the sense that users always need to know where they are. Navigation is also inherently “real-time”—position is calculated and reported immediately on satellite reception.

Geo-tagging, by contrast, is not necessarily real-time. What is of interest is where a user was at some time in the past. Furthermore, not all positions are equal—only certain events and places will be recorded. This leads to a strategy where satellite positioning is only executed at selected locations, in order to save battery power. As the current inventors have realised, however, this in turn leads to problems when these selected attempts at satellite positioning fail. For example, a user may find that some photos do not have locations that can be associated with them.

Nearly all current GPS receivers work by processing signals from the satellites in “real time”, as they come in, reporting the position of the device at the current time. Such “conventional” GPS receivers invariably comprise:

an antenna suitable for receiving the GPS signals,

analogue RF circuitry (often called a GPS front end) designed to amplify, filter, and mix down to an intermediate frequency (IF) the desired signals so they can be passed through an appropriate analogue-to-digital (A/D) convertor at a sample rate normally of the order of a few MHz,

digital signal processing hardware that carries out the correlation process on the IF data samples generated by the ND converter, normally combined with some form of micro controller that carries out the “higher level” processing necessary to control the signal processing hardware and calculate the desired position fixes.

The less well known concept of “Store and Process Later” (hereinafter “Capture and Process”) has also been investigated. This involves storing the IF data samples collected by a conventional antenna and analogue RF circuitry in some form of memory before processing them at some later time (seconds, minutes, hours or even days) and often at some other location, where processing resources are greater.

The key advantages of the Capture and Process approach over conventional GPS receivers are that the cost and power consumption of the capturing device are kept to a minimum as no digital signal processing needs be done at the time of capture, and the grabs can be very short (e.g. 100 ms). If the subsequent signal processing is done when the relevant satellite data (ephemeris etc) can be obtained via some other method, this approach also removes the need to decode the (very slow) data message from the SVs in the capturing device, which in many cases leads to unacceptably long times to start up conventional devices. The Capture and Process approach is therefore particularly relevant for geo-tagging scenarios.

The current invention is relevant to both real-time GPS and capture-and-process systems. The idea is that satellite positioning is attempted only for events of interest, and any missing position data is then inferred from contemporary events. Contemporary events (events at similar times) are likely to have positions closely correlated with the missing position.

This approach allows a position to be associated with every event. For example, position metadata can be embedded in every digital image captured by a camera. At the same time, power consumption and computational effort is minimized by not making repeated attempts at satellite reception. Repeated or periodic sampling may detect the restoration of satellite signal sooner, but this comes at the expense of battery life. By waiting until the next triggered event, the current method also increases the likelihood that the user has moved to a different location (where satellite reception might be improved) and avoids redundant failed reception attempts.

As a result of the methods of the invention, photos will have a location associated with them in more cases than would otherwise be the case, which for many applications is far better than having no fix.

FIG. 1 shows the steps in a method according to an embodiment. At step 10, a GPS receiver receives a trigger or event-indicator. This may be, for example, a camera shutter-release signal or a user pressing a button. In response, at step 20, the GPS receiver tries to receive signals from the SVs in a conventional manner.

This satellite-signal reception step is followed by an attempt 30 to derive a position estimate from the satellite signals which (it is hoped) were received in step 20. This attempt may be immediately after reception or may be more significantly delayed. For example, the attempt could be delayed until the next event is triggered and satellite reception is attempted again. In any case, if the attempt to calculate position is successful, the resulting estimate is used as the position of the event. If, on the other hand, the attempt 30 is unsuccessful, the estimate will be based on the positions of nearby events.

In one embodiment, the replacement position estimate is based on the nearest events before and after for which a position estimate is successful. These position estimates are retrieved (for example, retrieved from memory) in step 50. In order to use the position of a later event, the method requires that step 50 is carried later than a subsequent successful position fix. For example, steps 10 to 30 may have been successfully carried out for a subsequent event. For a real-time system, this means returning to earlier failed position estimates when a new event-position is calculated.

The available (“reference”) position estimates may be GPS (or other GNSS) position estimates; however, they may also be obtained from any other source. For example, it is known to perform position estimation based on observations of terrestrial transmitters, such as Wireless Local Area Network (WLAN) Access Points (APs) or cellular telephony base-stations. Sightings of a transmitter, or set of transmitters, can be compared with a database of transmitter locations, to produce a position estimate. In other embodiments, the position estimate for a reference position may be specified manually by a user.

The replacement position estimate can be based on one, two or more available reference positions. Typically, the accuracy will increase with the number of positions used. The event nearest in time to the event of interest should always be included in the estimation, since this has the greatest relevance and therefore accuracy.

Once suitable reference positions are available, the method proceeds to step 60: interpolating among the previous and/or subsequent position estimates to infer the missing position data. Various interpolation methods can be used, depending on the amount and type of information available. Examples of suitable interpolation methods will be described below.

The method of FIG. 1 is suitable for implementation in “real-time” GPS receivers, which update failed position estimates as soon as a sufficient number of surrounding, successful position-estimates is available.

The method of FIG. 2 relates to a capture-and-process scenario. A capture-and-process GPS device is deployed separately to perform steps 10 and 20 of FIG. 1. That is, the capture-and-process receiver performs satellite reception each time an event trigger occurs. The signals are stored as short sequences of IF data samples. Then, in a processing method according to the invention, the stored IF samples are uploaded 25 to a processing device, such as a personal computer (PC). The PC attempts to calculate position estimates from each of the fragments of satellite data. As before, if a position can be estimated from the satellite data, this position is used. If not, a position is interpolated from nearby successful estimates. Steps 50 and 60 are therefore as described above for the method of FIG. 1. Since, in this case, the full set of satellite data is available at the time of processing, there is no difficulty with causality. That is, there is no need to wait for events after the event of interest, because all events are in the past.

FIG. 3 shows an example apparatus according to an embodiment. This includes a camera 100 which provides shutter-release signals to a GPS receiver 200. The GPS receiver 200 is a capture-and-process receiver. It comprises an antenna 210 and GPS front end 220, connected to a micro-processor 230 and memory 240. A clock 250 can be included, to measure the time between events. The receiver 200 carries out method steps 10 and 20 described above as photographs are taken by the camera 100. The satellite data samples are stored in the memory 240. When the receiver 200 is connected to a PC 300, the stored data samples are uploaded to the PC 300, as in method step 25. The PC then carries out the remainder of the method shown in FIG. 2.

If the GPS receiver 200 is embedded in the camera 100, then the captured satellite-signal samples can be stored together with, or even in, the image-file. If the GPS receiver 200 is external to the camera, the trigger-signal (shutter-release) can be delivered via the camera hot-shoe. The hot-shoe connection is commonly used for connection of an external flash to a camera.

In another embodiment, the PC 300 may connect to a server (not shown in FIG. 3) to obtain full satellite ephemeris data. The availability of reliable ephemeris data from a separate source can make the processing of the satellite-signal samples more robust and efficient. Equally, the PC 300 may upload the samples to such a server, so that method steps 35, 40, 50 and 60 are carried out by the server. The enhanced computational power of the server can then enable the method to be carried out more quickly. The download of ephemeris data to the PC is also avoided in this way.

Interpolated fixes will typically be less accurate and reliable than positions computed directly from satellite data. This is especially true if the elapsed time between the failed fix and the successful one(s) used to create the interpolated position is high. Indeed, the interpolation algorithm may impose an upper limit on the allowable elapsed time to prevent the introduction of excessive errors. However, when the user has not moved much (or moved in a predictable manner) or the elapsed time is short, the interpolated fix is likely to be fairly accurate. For example, if a failed fix is within one minute of other successful fixes, then the interpolation is likely to be quite reliable. By contrast, if the nearest successful fix is many hours away, the interpolated value may be considered far less trustworthy. It may therefore be desirable to treat fixes at different intervals differently. In addition to the use of one or more thresholds to categorise available position fixes, other possibilities include weighting of data in proportion to the confidence attached to it.

Distance (between known positions) can also be used as a confidence indicator, as a supplement or alternative to time-difference between events. For example, interpolation in between two known positions, 5 km apart, is likely to be significantly less accurate than if the two positions were 500 m apart, even if the total time interval in both cases is 5 minutes. Another possibility is to filter or validate the interpolation result against any available constraints provided by the satellite data. Although the satellite data is presumably incomplete (since the position fix failed in the first instance), there may nonetheless still be some useful information embedded in the signals that can at least provide a practical check on the plausibility of the interpolated estimate. For example, in the capture and process case, once an interpolated position has been calculated, the ephemeris data for all satellites can be downloaded. It is then possible to determine the satellites that should have been visible at the time and (interpolated) position of the event. If satellites detected in the received signal-samples were, in fact, below the horizon at the estimated time and position, then the interpolated position estimate is known to be invalid. This is just one crude example of validation based on received satellite signal data. Often, it will be possible to perform much more accurate checks. In another example, if just two satellite signals are detected and pseudo ranges calculated, the attempt, in step 35, to compute a position estimate will fail. Nonetheless, given an interpolated position estimate (from step 60), it will be easy to determine whether that position estimate falls within the locus of points for which the two known pseudo-ranges are valid. Agreement between the available satellite data and the interpolated estimates can therefore provide a powerful indication of the validity or accuracy of, or confidence in, estimates.

It may be advantageous to inform the user of the likely lower accuracy or reliability, via the user-interface, when a position estimate is interpolated. This may comprise displaying interpolated fixes in a different manner (for example, if plotted on a map, using an alternative symbol; highlighted in a different colour; or with a blurred background). Alternatively, the user-interface may provide a numerical estimate of accuracy. If thresholds or confidence data are used, this information can also be presented graphically or numerically, for example by distinguishing between “trusted” estimates and less confident “guessed” estimates.

Some geo-tagging applications offer reverse geo-coding. This involves using the position estimate to find a place-name or address from a database. It is very likely that interpolated positions will be sufficiently precise to find accurate addresses. Therefore, in this case, the user may not even notice that interpolated positions have been used.

One suitable method for performing interpolation will now be described. Suppose an interpolated position P is needed for an event at a time tₚ. There will be a number of other events and thus received satellite signals that are associated with the same device. Of these, there will be some that have positions associated with them through a successful fix (or by other means). From this set, S, the method selects A1, the “previous” event whose time, t_{A1}, is closest to t_{P} whilst still being earlier than t_{P} and B1, the “next” event whose time, t_{B1}, is closest to t_{P} whilst still being later than t_{P}.

A threshold can be employed to limit the selection of A1 and B1, so that no satellite signals are considered if their time of capture (that is, the time of the associated event) is more than a certain interval from t_{P}. In other words, the set S is the set of events (and signal captures) for successful fixes with timestamps within a given amount of t_{P}.

Whether or not a threshold is imposed, it is of course possible that A1 or B1 do not exist (for instance if there is no successful fix before tₚ). If neither A1 nor B1 exist, then the method cannot produce an interpolated location. If both A1 and B1 exist, then the method determines the interpolated latitude, longitude and altitude by simple linear interpolation between the latitude, longitude and altitude associated with A1 and B1. Representing the required lat, long and alt as a vector x_{P} and those of A1 and B1 as x_{A1} and x_{B1} respectively, then:

x_{P}=x_{A1}+(x_{B1}−x_{A1})*(t_{P}−t_{A1})/(t_{B1}−t_{A1})

If only A1 exists then:

x_{P}=x_{A1}

On the other hand, if only B1 exists then:

x_{P}=x_{B1}

As will be readily apparent to the skilled person, other interpolation algorithms may be used. The choice of algorithm will depend on factors such as the number of positions (or other trajectory information) being used for interpolation, the accuracy desired and the computational power available.

As will also be readily apparent, it is necessary to produce and store timing information about the relative delays between the events, in order to carry out the interpolation described above. This can be provided by a clock 250, as in FIG. 3, or simply by a counter.

Note that longitude needs to be handled carefully, due to its circular nature. For example, −179.9 deg is very close to +179.9 deg; the correct interpolated value half way between the two is likely to be 180 deg (not 0 deg). Problems can be avoided by “unwrapping” the longitude angle—that is, adding or subtracting 360 deg, as appropriate, when the numerical difference between any two values is greater than 180 deg.

FIG. 4 illustrates several options. Stars are used to indicate the known (successfully calculated) positions, which form the basis for interpolation. A solid dot indicates the interpolated position for the event of interest. The dashed line shows the interpolated trajectory between the reference positions, A and B. The first example in FIG. 4 corresponds to the linear interpolation example above.

In the second example, higher-order interpolation is used, based on measurements v_{A2}, v_{B2} of velocity at the known positions A2 and B2, respectively. In practice, this velocity could be calculated from GPS Doppler measurements or measured by any other direction and speed sensing means.

In the third example, three points are used for interpolation: two, A3 and C3, from before the event of interest and one, B3, from after it. Once again, non-linear interpolation is used, by applying the constraint of smoothness of the trajectory through the three known points. The smoothness assumption may have limited validity in some applications, and so, in practice, linear interpolation will be as accurate as any other approach.

Knowledge of likely routes can be a useful further aid to interpolation. For example, if a map is available showing roads and paths, the position of an event of interest can be interpolated along these routes, instead of in arbitrary trajectories. Information about the journeys commonly taken by a given user can be used in the same way: if the same route is taken many times, it could be assumed that, if the known reference positions forming the basis for interpolation lie on the route, the position estimate of the event of interest should also lie on the route.

Although the methods of the invention have been described primarily in the context of photography and geo-tagging photographing locations, the events of interest are not limited to image capture. Indeed a user can indicate an event of arbitrary type by pressing a “manual override” button which forces the satellite reception function.

Two example embodiments of methods according to the invention have been described. The first, shown in FIG. 1, relates to real-time satellite positioning; the second, shown in FIG. 2, relates to capture-and-process satellite positioning. In the first case, all processing is performed “on-line” at the point of reception of the satellite signals. In the second case, minimal processing is performed at the receiver, in order to sample and store the satellite signals. All other processing is deferred until a later time, when the data is uploaded to a PC. As will be apparent to the skilled person, however, the scope of the invention is not confined to these two extreme cases. The processing burden may be shared in any suitable proportion between the receiver and PC. In one example, the receiver may perform processing to determine the code phase measurement from the satellite signals. In a second example, the processing may continue, to calculate pseudo-ranges to as many satellites as possible. In either case, associated frequency and Doppler measurements may also be computed.

These examples require increasing amounts of processing power, compared to a “pure” capture-and-process-later approach; they also typically require increasingly long sequences of satellite data-samples to be received. For example, although a capture-and-process receiver may record just 100 ms of satellite signals, 1s will typically be needed to compute a pseudo range. Of course, the benefit of the longer sequence-length and the extra processing effort is that the likelihood increases that it will later be possible to successfully compute a position estimate. For example, if pseudo-ranges have been calculated at the receiver, there is a high likelihood that a position fix will be successful. Failure is still possible, but only in limited cases, such as incorrect synchronization of the satellites themselves; unhealthy satellites; or very poor satellite geometry.

As already mentioned above, a server may be used to perform some or all of the steps of a method according to an embodiment. In the particular embodiment described above, the server implemented the invention in a capture-and-process scenario. In that case, the server receives the satellite signal samples from the receiver (via a PC), processes the satellite signals in an attempt to calculate position estimates and performs any necessary interpolation. However, the server may implement only part of the method. For example, the server may receive calculated position estimates for certain events along with timing information, and also receive timing information of events for which a position estimate was unsuccessful. The server then carries out only steps 40, 50 and 60 of FIG. 1 or 2. That is, the server performs interpolation to estimate the unknown positions, based on the position estimates of the other events which were provided to it. The server can be applied in this way regardless of whether the overall method is implemented as a real-time or capture-and-process satellite positioning scenario (or any variation in between these extremes). Interpolation at the server may be beneficial for photo-sharing via the internet. For example, a user may upload selected photos and associated position fixes in a first upload task. One of the photos may have a missing or failed position fix. The server interpolates a position estimate for this photo, based on the other, available photo-positions. Subsequently, the user may upload further selected photos, with further associated positions, in a second upload task. Some of these additional photos may be closer to the time of the photo for which a position was interpolated—that is, they may offer the possibility of more accurate interpolation. The server can then amend the interpolated position estimate of the photo in question, based on the newly available information.

Various other modifications will be apparent to those skilled in the art.

1. A method of estimating the position of a first event among a series of events of interest using a satellite positioning system, the method comprising:
performing in response to the first event a satellite reception function comprising attempting to receive signals from satellites;
determining at some later time whether it is possible to calculate a position for the first event from the received satellite signals; and, if not,
estimating the position of the first event based on a position of a second event among the series of events, wherein the second event is that closest in time to the first for which a position is known,
so as to provide a position estimate for the first event even if the satellite reception function fails.

2. The method of claim 1, wherein the second event occurred after the first.

3. The method of claim 2, comprising, if it is not possible to calculate a position from the received satellite signals, estimating the position of the first event based on the position of the second event and a position of a third event among the series of events, wherein:
the third event occurred before the first; and
the step of estimating the position of the first event comprises interpolating between the positions of the second and third events.

4. The method of claim 3, wherein at least one of the second and third events occurred within a predetermined maximum time limit before or after the first event.

5. The method of claim 1 comprising, if it is not possible to calculate a position from the received satellite signals, estimating the position of the first event based on a velocity estimate associated with the time and position of at least one event.

6. The method of any of claim 1, wherein at least one of the first event and the second event is the taking of a photograph.

7. The method of claim 1, further comprising alerting a user to the potentially reduced accuracy of the estimated position.

8. A method of estimating the position of a first event among a series of events of interest using a satellite positioning system, the method comprising:
receiving recorded data samples of satellite signals, the data samples resulting from a satellite reception function, the satellite reception function having been performed in response to the first event;
determining whether it is possible to calculate a position for the first event from the recorded data samples; and, if not,
estimating the position of the first event based on a position of a second event among the series of events, wherein the second event is that closest in time to the first for which a position is known,
so as to provide a position estimate for the first event even if the satellite reception function failed.

9. A computer program comprising computer program code means adapted to control a GPS receiver to perform all the steps of claim 1 when said program is run on a computer.

10. A computer program as claimed in claim 9 embodied on a computer-readable medium.

11. Apparatus adapted to estimate the position of a first event a series of events of interest using a satellite positioning system, the apparatus comprising:
a receiver, adapted to perform in response to the first event a satellite reception function comprising attempting to receive signals from satellites; and
a processor, adapted to determine at some later time whether it is possible to calculate a position for the first event from the received satellite signals and, if not,
to estimate the position of the first event based on a position of a second event among the series of events, wherein the second event is that closest in time to the first for which a position is known,
so as to provide a position estimate for the first event even if the satellite reception function fails.

12. The apparatus of claim 11, wherein the second event occurred after the first.

13. The apparatus of claim 12, wherein the processor is adapted, when it is not possible to calculate a position from the received satellite signals, to estimate the position of the first event based on the position of the second event and a position of a third event among the series of events, wherein:
the third event occurred before the first; and
the processor estimates the position of the first event by interpolating between the positions of the second and third events.

14. The apparatus of claim 11, wherein:
the receiver is connected to a camera; and
at least one of the first and second events is the taking of a photograph by the camera.

15. Apparatus adapted to estimate the position of a first event among a series of events of interest using a satellite positioning system, the apparatus comprising:
an input, operable to receive recorded data samples of satellite signals, resulting from a satellite reception function, the satellite reception function having been performed in response to the first event; and
a processor, adapted to determine whether it is possible to calculate a position for the first event from the recorded data samples, and, if not,
to estimate the position of the first event based on a position of a second event among the series of events, wherein the second event is that closest in time to the first for which a position is known,
so as to provide a position estimate for the first event even if the satellite reception function failed.

16. A computer program comprising computer program code means adapted to control a processor to perform all the steps of claim 8 when said program is run on a computer.

17. A computer program as claimed in claim 11 embodied on a computer-readable medium.
